(19) United States
(12) Patent Application Publication
(10) Pub. No.: US 2016/0378745 A1
(43) Pub. Date: Dec. 29, 2016

(54) Method of retrieving tagged documents

(71) Applicant: Asham Elrayess, Kanata (CA)

(72) Inventor: Asham Elrayess, Kanata (CA)

(21) Appl. No.: 14/545,850

(22) Filed: Jun. 29, 2015

(51) Int. Cl. G06F 17/27

(52) U.S. Cl. CPC G06F 17/277

(57) ABSTRACT

Documents and in particular PDF documents are made available to people with disabilities using an algorithm which obtains an original tag containing content to be used to identify text, inspecting text containing the tag while ignoring any leading or trailing spaces or special characters, obtaining dominant identifying text, searching the entire document for text using the same identifying text, accumulating text runs until a change in such text is found, and placing accumulated text in a tag similar to that used by the original tag.

This invention relates to a method for making documents accessible to people with disabilities.

In particular, the invention relates to a method, which employs an algorithm for making PDF documents accessible to people with disabilities. Such documents need to be tagged as a pre-requisite for being accessible. The method described herein improves the efficiency of tagging under certain circumstances.

The algorithm employed by the method reduces the amount of time required to retrieve PDF documents (and potentially other file formats) by using tagging information that the user has already specified and tagging similar pieces of content in the documents. It currently uses the font information of the text to identify text to be tagged in a similar manner.

In general, the algorithm performs the steps of:

obtaining an original tag containing tagging information used to identify text;

inspecting the text containing the tag;

searching an entire document for the text using the tagging information;

once the identifying text is found, accumulating text runs until a change in the identifying text is found; and

placing accumulated text in a tag similar to that used by the original tag.

Specifically, the algorithm used to perform the method of the present invention functions as follows:
1) Obtains the tag containing the content to be used,
2) Inspects the text contained in the tag
   a) Ignoring any leading or trailing spaces or special characters as these might be provided in a different font.
   b) Obtains the dominant font in the text (usually of one type).
3) Searches the entire document for text that uses the same font. Once this text is found, accumulates the text runs until a change in font is found. Spaces and special characters are ignored.
4) Places the accumulated text in a tag similar to that used by the original tag.

1. A method of making documents accessible to people with disabilities comprising the steps of:
obtaining an original tag containing tagging information used to identify text;
inspecting the text containing the tag;
searching an entire document for the text using the tagging information;
once the identifying text is found, accumulating text runs until a change in the identifying text is found; and
placing accumulated text in a tag similar to that used by the original tag.

2. The method of claim 1, wherein the document is a PDF document.

3. The method of claim 2, wherein font information of the text is used to identify text to be tagged.

4. The method of claim 3, wherein, when inspecting the text to be tagged, any leading or trailing spaces, or special characters which might be provided in a different font are ignored, and the dominant font in the text is obtained.

5. The method of claim 4, wherein spaces and special characters are ignored when searching the entire document.
